(19) United States
(12) Patent Application Publication
(10) Pub. No.: US 2015/0324106 A1
(43) Pub. Date: Nov. 12, 2015

(54) USER INTERFACE, METHOD, AND COMPUTER PROGRAM FOR DISPLAYING DATA

(71) Applicant: Brewer Science Inc., Rolla, MO (US)

(72) Inventors: Adam C. Lewis, Owensville, MO (US); Kevin Edwards, Rolla, MO (US)

(21) Appl. No.: 14/704,153

(22) Filed: May 5, 2015

Related U.S. Application Data
(60) Provisional application No. 61/989,168, filed on May 6, 2014.

(51) Int. Cl. G06F 3/0484; G06Q 40/00; G06F 3/0482

(52) U.S. Cl. CPC G06F 3/04847; G06F 3/0482; G06Q 40/00

(57) ABSTRACT

A user interface for monitoring a number of parameters of a system includes an electronic display element and a display driver for controlling the electronic display element so as to display a data graph thereon. The data graph includes a bounded area divided into a plurality of segments, each segment representing one of the parameters; and a number of concentric portions formed in each segment, each concentric portion representing a state or value of the parameter represented by its corresponding segment. The display driver receives data representative of a current state or value of each of the parameters and indicates the current state or value of the parameters by marking the concentric portions that represent the current states or values.

### RELATED APPLICATION

The present application is a non-provisional patent application and claims priority benefit, with regard to all common subject matter, of earlier-filed U.S. provisional patent application titled “METHOD AND APPARATUS FOR DISPLAYING MULTIPLE TYPES OF DATA IN REAL TIME,” Ser. No. 61/989,168, filed on May 6, 2014, incorporated by reference in its entirety into the present application.

### BACKGROUND

Data is often displayed on graphs for monitoring and/or analysis purposes. Many different types of graphs and data mapping techniques exist including line graphs, bar graphs, area graphs, surface graphs, two, three and four-dimensional contour graphs, bubble graphs, column graphs, heatmaps, treemaps, spider charts, etc. Many of these graphs can also be combined with color mapping procedures wherein data values within the graph are indicated through means of a color display or color “values.” Color can be used to indicate a value, to enhance certain characteristics of the data, or to indicate priorities or alerts. Color mapping is used, for example, in line graphs, contour maps, heatmaps, treemaps, and in imaging applications including medical imaging, radar, and other sensor data display. A few of these graphing techniques will now be described in more detail.

Line/point charts allow data to be seen at a glance, and can be used to compare multiple categories of data. In a line chart, each data series is marked with a point on an x-y axis, with one variable, such as time, proceeding across the x-axis, and the value or state of that variable on the y-axis, and the points are often connected with a line to show trends and the relationship between the points. Multiple data series can be shown on one chart, as long as at least one of the axes is common among all of the data series. However, large sets of data can be difficult to view on line/point charts, both on the horizontal and vertical axes, especially when such charts are displayed in small areas as discussed below.

Bar/column charts typically allow viewers to recognize data more easily than with line/point charts, and they can be used to compare multiple categories of data. As with line charts, each data series is marked on an x-y axis, with one variable across the x-axis, and the value or state of that variable marked by a bar starting at the x-axis and going up to the appropriate value on the y-axis. Again, multiple data series can be shown on one chart, as long as at least one of the axes is common among all of the data series. The solid bars of bar/column charts allow data to be seen and recognized quickly even from a distance. However, only data points or categories that are close together can be easily compared, and as more data points or categories are displayed, the space required to show all of the data can become very large. It is especially difficult to compare data points on opposite ends of the chart.

Pie charts can contain large data sets in small footprints, and their solid blocks can be viewed from a distance or in a small area. In a pie chart, at least two data series must be present, and the percentage of each data series compared to the sum of all of the data series is represented as a radial percentage of a circle. Unfortunately, pie charts are only able to display one value for any given data point or series (such as percentage).

Donut charts are similar to pie charts, in that each section of the donut chart can be broken down into some smaller portions, but these portions can be small and difficult to see in a small area, and can also be difficult to compare across different sections of the chart.

Spider charts are similar to line/point charts, and offer some of their advantages, and are also similar to pie charts and offer some of their advantages as well. In a spider chart, the state or value of each data point or category is shown by its distance radially from the center of a circle, similar to the y-axis on a line chart. Like a pie chart, larger amounts of data can be shown in a smaller space, and it is often easier to compare the different states. However, like a line graph, the points can be easily lost, especially in a small space and with a large number of data points or categories. A spider chart requires at least three data series in order to produce a shape, and the asymmetrical shapes it produces aren't easily identifiable.

A few specific limitations of the above-described graphs, data displaying techniques, and color mapping techniques will not be discussed in more detail. As mentioned above, prior art graphs are generally limited in the number of variables which they can display simultaneously while still allowing differentiation of individual variables and/or values within the graph. For example, a line graph with multiple time series or variables typically looks cluttered and the data therein becomes intertwined, making differentiation between individual time series variables difficult if not impossible. One solution is to stack multiple graphs to view simultaneously, but this solution is limited in the number of graphs that can be displayed and it can be difficult to make comparisons across the graphs. This problem is especially acute when graphs are presented on displays having a small display area such as displays on mobile phones and other hand-held communication devices.

Another limitation of prior art graphing and data displaying techniques is that for a number of data series to be effectively graphed, the data needs to be in a relatively narrow or common range. This problem occurs both in line graphs and in color contour mapping. On a line graph, when the data is not in a common range, it must be transformed, normalized, or standardized to a common scale, or a variable must be selected which is in a common range.

Another limitation of prior art graphing and data displaying techniques is that the images created are generally limited and static. The data in the graph or map is selected, any sorting or arrangement is made, and the image then constructed.

These and other limitations of prior art graphs make them generally unsuitable for use in monitoring systems that have multiple parameters or variables. This is especially true when the graph must be displayed via small display screens on mobile phones and the like.

### SUMMARY

The present invention solves the above-described problems and provides a distinct advance in the art of graphs and related data display techniques. More particularly, the present invention provides an improved data graph that displays data in such a way that it can be quickly and easily interpreted, even when large sets of data are displayed, viewers are far from the data graph, and/or the data graph is rendered on a small display screen such as those on mobile phones. The data graph may be implemented with any user interface, system, method, or computer program and may be used for displaying data from any system, device, or entity such as a manufacturing system or financial system.

An embodiment of the data graph comprises a bounded area divided into a plurality of segments, with each segment being further subdivided into a number of concentric portions. In one embodiment, the bounded area is circular or donut-shaped, the segments are equally-sized pie-shaped radial segments; and the concentric portions have the same diameter, with an equal number of concentric portions being formed in each segment.

The data graph may be used to monitor a system with a number of parameters each having several values or states. Each segment of the data graph may represent one data series or parameter of the system; and each concentric portion may represent one state or value of its corresponding data series or parameter. For example, if the data graph is used to monitor the status of a piece of equipment in a manufacturing system that reports data for pressure, temperature, humidity, liquid level, and force, the data graph may be divided into five radial segments (one for each of these five parameters). If each of these parameters has three values or states, for example, a desired or safe value or state, a low value or state, and a high value or state, each segment of the data graph may be divided into three concentric portions (one for each possible state or value).

In one embodiment, the innermost concentric portion of each section represents the lowest state or value of its corresponding parameter and the outermost concentric portion represents the highest state or value of its corresponding parameter. Using the example in the previous paragraph, the innermost concentric portions may represent the low values or states of pressure, temperature, humidity, liquid level, and force; the middle concentric portions may represent the desired or safe values or states of pressure, temperature, humidity, liquid level, and force; and the outermost concentric portions may represent the high values or states of pressure, temperature, humidity, liquid level, and force. Because each segment preferably contains the same number of concentric portions and the concentric portions each have the same diameter or radial thickness, the innermost concentric portions form a relatively unbroken ring near the center of the data graph, the middle concentric portions form a relatively unbroken ring near the mid-point of the data graph, and the outermost concentric portions form a relatively unbroken ring adjacent the other circumference of the data graph.

The current values or states of the parameters of the system being monitored may be represented on the data graph in a number of ways. In one embodiment, the current values or states are represented by marking the concentric portions that represent these current states or values. For example, if the current states or values of the parameters of the above-described system are all in the desired or safe range, the middle concentric portions of all the segments are marked so as to form a relatively unbroken ring near the mid-point of the data graph. But if any of the parameters is in a low value or state, the corresponding innermost concentric portion is marked so as to form a “break” in the ring to alert a viewer that one of the parameters is below its desired state or value. Likewise, if any of the parameters is in a high value or state, the corresponding outermost concentric portion is marked so as to form a “break” in the ring to alert a viewer that one of the parameters is above its desired state or value.

The concentric portions may be marked to indicate the current value of states in a number of ways. In preferred embodiments, the concentric portions are marked by coloring them, and the colors vary depending on the current states or values. For example, the concentric portions that represent the desired or safe values or states may be colored green, and the concentric portions that represent the high and/or low values or states may be colored yellow or red. Such a color scheme further draws the viewer's attention to any alarm, danger or other outlier conditions. For example, an unbroken ring of green indicates that all the parameters are in a desired state or value, but a broken ring with some yellow or red concentric portions indicates that some of the parameters are outside a desired state or value.

In other embodiments, the concentric portions may be marked by shading or cross-hatching. The concentric portions may also be marked with LEDs or other hardware components of the device on which the data graph is displayed.

The concentric portions and/or the radial segments of the data graph may also be linked to data tables or other data sources so that specific data may be displayed when a user clicks-on, hovers-over, or otherwise selects a particular concentric portion. This allows a viewer to quickly and easily learn more about a parameter that is currently outside its desired value or state.

The above described data graph allows a user to see, at a glance, the current state or states of a system via a symmetrical grid. The design of the data graph takes advantage of a viewer's natural pattern recognition abilities to quickly identify non-conforming data points. In addition to leveraging pattern recognition, the design of the data graph uses both position and color variations to indicate data, making it unambiguous even to colorblind users. The data graph combines the benefits of a column/bar graph to represent state, and a pie/spider chart to contain the data set (i.e., large data sets can be seen in a small space). The invention also provides ways to interact with the data graph. The unique combination of these technologies allows for a compact and highly intuitive user interface.

The above-described data graph may be implemented in any device, system, or method. In one embodiment, it is implemented with a user interface that monitors a manufacturing system or other system that has a number of parameters each having a number of states or values. The user interface comprises an electronic display element and a display driver for controlling the electronic display element so as to display the data graph thereon. The display driver receives data representative of a current state or value of each of the parameters and indicates the current state or value of the parameters by marking the concentric portions that represent the current states or values.

In other embodiments, the data graph may be implemented in a monitoring system for monitoring a number of parameters of a manufacturing system or other system. The monitoring system comprises a plurality of sensors each configured for monitoring a parameter of the system; a controller for receiving signals from the sensors, wherein the signals represent the current states or values of the parameters; and a user interface coupled with the controller for displaying the data graph. The user interface may be implemented by a smart phone, laptop computer, or other electronic device that may comprise a wired or wireless communication component operable to receive data representative of the signals from the controller; an electronic display element; and a display driver for controlling the electronic display element so as to display the above-described data graph thereon. In other embodiments, the user interface may be integrated into a piece of equipment or other device being monitored by the monitoring system.

In yet another embodiment, the data graph may be implemented with a non-transitory computer-readable medium having one or more computer programs stored thereon for controlling operation of an electronic display element. The computer programs instruct the display element to display the above-described data graph.

In yet another embodiment, the data graph is implemented in a method of indicating a current status or value of a number of parameters of a manufacturing system or other system. The method comprises receiving data representative of a current status or value of each of the parameters; displaying the above-described data graph on an electronic display element; and indicating the current status or values of the parameters by marking the concentric portions of the data graph that represent the current states or values.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

The file of this patent contains at least one drawing executed in color. Copies of this patent with color drawing(s) will be provided by the Patent and Trademark Office upon request and payment of the necessary fee.

Embodiments of the present invention are described in detail below with reference to the attached drawing figures, wherein:

FIG. 1 shows a data graph constructed in accordance with various embodiments of the invention without any data presented on the graph.

FIG. 2 shows the data graph of FIG. 1 with one of its radial segments highlighted.

FIG. 3 shows one radial segment of the data graph of FIG. 1 in more detail with its concentric portions numbered.

FIG. 4 shows an embodiment of the data graph with data represented thereon;

FIG. 5 also shows an embodiment of the data graph with data represented thereon;

FIG. 6 also shows an embodiment of the data graph with data represented thereon;

FIG. 7 also shows an embodiment of the data graph with data represented thereon;

FIG. 8 shows an embodiment of the data graph as it may appear on a display device accompanied by textual and/or numerical representations of the data shown on the data graph.

FIG. 9 shows another embodiment of the data graph as it may appear on a display device accompanied by textual and/or numerical representations of the data shown on the data graph.

FIG. 10 shows a data graph constructed in accordance with other embodiments of the invention.

FIG. 11 is a block diagram showing selected components of a user interface that may be used to create and/or display embodiments of the data graph.

FIG. 12 is a schematic diagram of selected components of a monitoring system that may be used to collect data and then display the data on various embodiments of the data graph.

FIG. 13 is a flow diagram that depicts steps in an exemplary method of the present invention and/or portions of a computer program of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

The present invention provides an improved data graph and a user interface, monitoring system, computer program, and method for implementing the data graph. The data graph displays data in such a way that viewers can quickly and easily view and interpret data displayed thereon, even when large sets of data are displayed, the viewers are far from the display graph, and/or the display graph is rendered on small display screens such as those on mobile phones. The data graph may be used for displaying data from any system, device, or entity such as a manufacturing system or financial system.

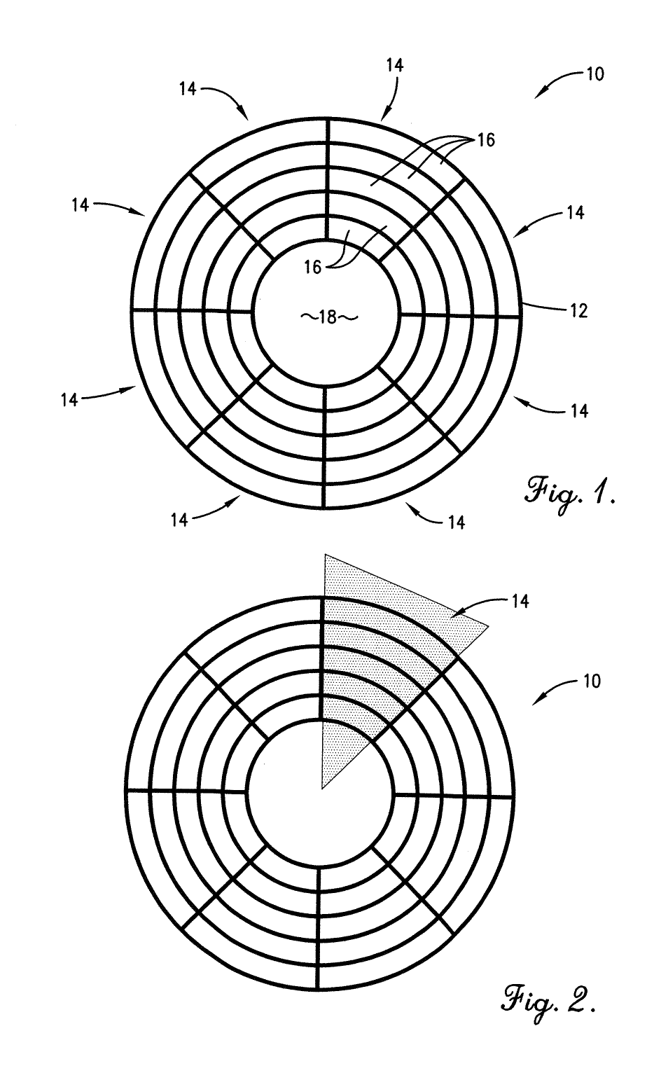

FIG. 1 shows the general structure of a data graph 10 constructed in accordance with embodiments of the invention. The illustrated data graph 10 broadly comprises a bounded area 12 divided into a plurality of segments 14, with each segment 14 being further subdivided into a number of concentric portions 16. The data graph 10 may be of any shape and size and configured to fit on any display area. The data graph 10 may also be configured to present any type or quantity of data.

In one embodiment, the bounded area 12 of the display graph is circular or donut-shaped, but it can be square, rectangular, triangular, or any other shape. The bounded area 12 preferably has radial or rotational symmetry around a central point, with at least n-fold symmetry, where “n” is the number of data series or parameters to be displayed on the data graph 10. The bounded area 12 may have a hole or opening 18 in its center, the purpose of which is discussed below. The bounded area 12 preferably has one background color, such as white, gray or black.

The bounded area 12 is divided into a number of segments 14, that preferably extend radially from the center of the bounded area. FIG. 2 shows an exemplary data graph with one radial segment shaded or highlighted. The segments 14 are preferably equal in size, but can be of unequal sizes. In the case of a circular bounded area 12 as shown in the drawing figures, the data graph 10 is divided into equal “pie”-shaped segments. Embodiments of the data graph may have from about 1 to about 100 radial segments 14, more preferably from about 2 to about 50 radial segments, and even more preferably from about 3 to about 16 radial segments. The radial segments 14 may or may not be separated, such as by lines or spaces.

Each segment 14 is further separated into a number of concentric portions 16. The concentric portions may or may not be visibly separated, such as by lines or spaces. Each segment 14 may have any number of concentric segments 16. Preferably, each segment 14 has from about 2 to about 20 concentric portions, more preferably from about 3 to about 10 concentric portions, and even more preferably from about 3 to about 5 concentric portions. The segments 14 preferably each have the same number of concentric portions 16, and each concentric portion has the same diameter or radial thickness. FIG. 3 shows one radial segment 14 of an exemplary data display 10 with five concentric portions 16, each numbered 1-5 for reference.

When the data graph 10 is used to monitor a system having a number of parameters, each radial segment 14 represents one parameter or data series and each concentric portion 16 represents one data value or state of the data series. A “data series” is a set of corresponding data values or states of the same parameter. In each data series, multiple states or values can be represented, such as a numerical value, temperature, pressure, force, velocity, humidity, capacity, time remaining, and mode of operation. Optionally, more than one state of a data series maybe represented in one radial segment 14. Each radial segment could also represent the same parameter of different equipment, different bottles, etc. The concentric portions 16 represent different values or states of the data series for that specific radial segment.

For example, if the data graph 10 is used to display data for a manufacturing system that senses data for the parameters of pressure, temperature, humidity, liquid level, and force, the data graph 10 may be divided into five radial segments 14 (one for each of these five parameters). If each of these parameters has three values or states, for example, a desired or safe value or state, a low value or state, and a high value or state, each segment 14 of the data graph is divided into three concentric portions 16 (one for each possible state or value).

In one embodiment, the innermost concentric portion of each section represents the lowest state or value of its corresponding parameter or data series and the outeimost concentric portion represents the highest state or value of its corresponding parameter or data series. Continuing with the example mentioned above, if the data graph 10 has five radial segments 14 for representing pressure, temperature, humidity, liquid levels, and force, and each segment 14 has three concentric portions 16 for representing a low, safe, and high state of its parameters, the innermost concentric portions may represent the low values or states of the parameters; the middle concentric portions may represent the desired or safe values or states of the parameters; and the outermost concentric portions may represent the high values or states of the parameters.

Because each segment 14 preferably contains the same number of concentric portions 16 and the concentric portions 16 each have the same diameter or radial thickness, the innermost concentric portions form a relatively unbroken ring near the center of the data graph, the middle concentric portions form a relatively unbroken ring near the mid-point of the data graph, and the outermost concentric portions form a relatively unbroken ring near the periphery of the data graph. This same principle applies for configurations of the data graph with more or less concentric portions in each segment.

Data may be represented on the above described data graph 10 in a number of ways. For example, the segments 14 of the data graph may each be assigned to a particular parameter of a manufacturing system, and each concentric portion 16 within a segment may be assigned to a specific state or value of its corresponding parameter. The current values or states of the parameters may then be represented on the data graph 10 by coloring or otherwise marking the concentric portions that represent these current states or values.

In some embodiments, the colors used to mark the concentric portions vary depending on the current states or values. At least one color besides the background color must be used in order to mark different radial segments 14 or concentric portions 16. Preferably, more than one color is used to mark different segments or portions. For instance, “safe” values could be shown in green, while “unsafe” values could be shown in red. Or, low values could be shown in red, and high values in green. Or, cold values could be shown in blue, while hot values are shown in red.

Use of colors to mark the concentric portions 16 further draws a viewer's attention to any alarm, danger or other outlier conditions. For example, an unbroken ring of green indicates that all the parameters are in a desired state or value, but a broken ring with some yellow or red concentric portions indicates that some of the parameters are outside a desired state or value.

Moreover, the relative positioning of the concentric portions 16 and the coloring used to mark the concentric portions 16 may cooperatively assist a viewer in recognizing and understanding the data. For example, by assigning the inner concentric portions to low values or states and coloring them red or yellow, assigning the middle concentric positions to safe values or states and coloring them green, and assigning the outer concentric portions to high values or status and coloring them yellow or red, viewers can quickly and easily recognize alarms, outliers, etc. by their color and their position. Thus, if the current states or values of the parameters of the above-described exemplary system are all in the desired or safe range, the middle concentric portions are all colored or otherwise marked so as to form a relatively unbroken green ring near the mid-point of the data graph. But if any of the parameters is in a low value or state, the corresponding innermost concentric portion is colored red or yellow or otherwise marked so as to form a “break” in the ring to alert a viewer that one of the parameters is below its desired state or value. Likewise, if any of the parameters is in a high value or state, the corresponding outermost concentric portion is colored red or yellow or otherwise marked so as to form a “break” in the ring to alert a viewer that one of the parameters is above of its desired state or value.

The way data is displayed on the data graph 10 can vary depending on the application. For instance, when displaying processing parameters from a manufacturing system, it may be advantageous to normalize the data so that the “in-spec” values are in the middle concentric portions, the “low” values are toward the center of the data graph, and the “high” values are toward the edge of the data graph.

In one embodiment of the data graph shown in FIG. 3, each segment 14 of the data graph 10 includes five concentric portions 16, with the most centrally-located portions representing a “low critical” state (state “1” in FIG. 3) and being assigned the color red, the next portion out representing a “low warning” state (state “2” in FIG. 3) and being assigned the color yellow, the next portion out representing a “safe” state (state “3” in FIG. 3) and being assigned the color green, the next portion out representing a “high warning” (state “4” in FIG. 3) and being assigned the color yellow, and the outermost portion representing a “high critical” state (state “5” in FIG. 3) and being assigned the color red. In this embodiment, if all parameters are in the “safe” state, then the concentric portion representing the “safe” state (state “3” in FIG. 3) are marked green. In this case, a viewer would see an unbroken green circle occupying the middle concentric portions. However, if any parameter varied from the “safe” state, then the circle would be broken, and at least one radial segment would show a yellow or red color.

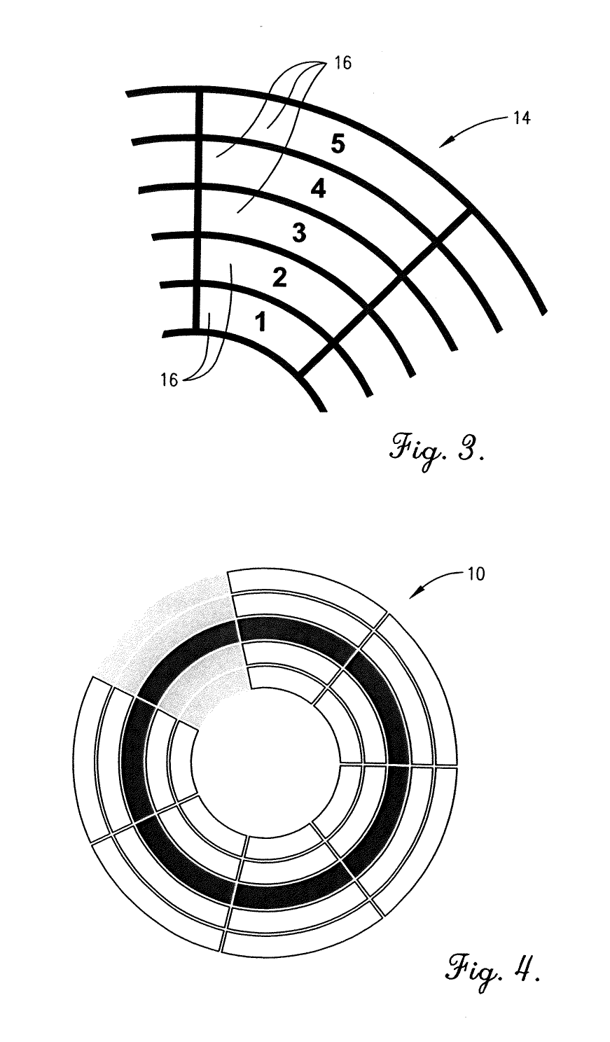

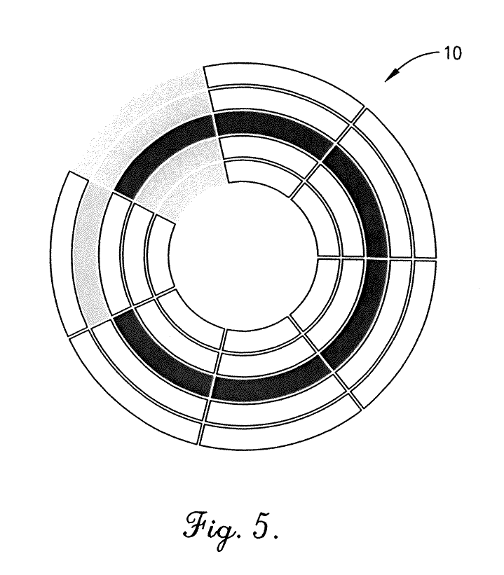

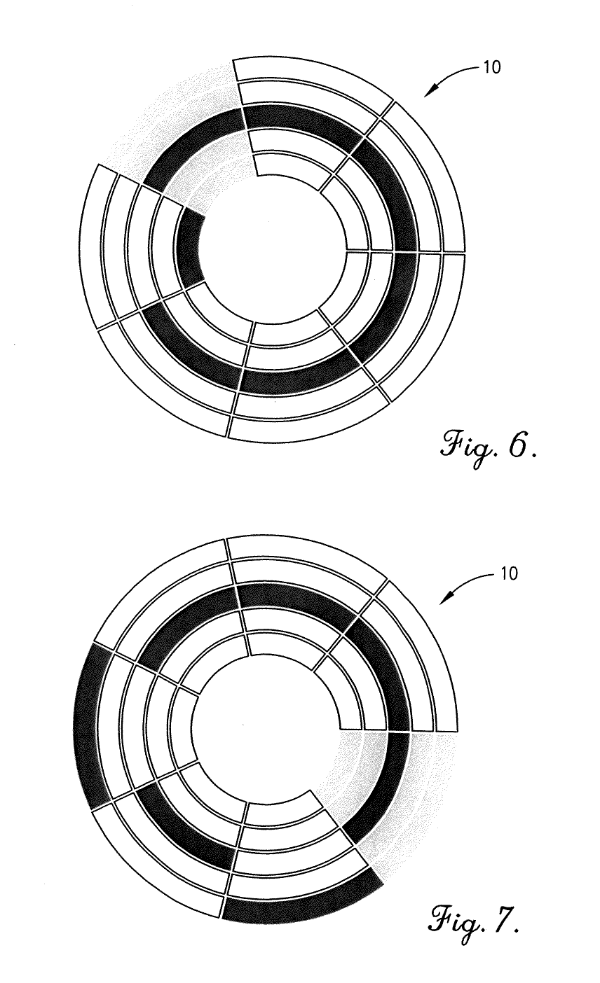

FIG. 4 shows an exemplary data graph 10 where all the parameters or data series are in a “safe” state. FIG. 5 shows the same data graph 10 with the left-most radial segment representing a “high warning” level and all other segments in “safe” range. FIG. 6 shows the same data graph with the left-most radial segment representing a “low critical” level and all other segments in a “safe” range. FIG. 7 shows the data graph with two radial segments representing a “high critical” state.

The data displayed on the data graph 10 could be normalized so that the “safe” range is at the inner edge (state “1” in FIG. 3) and increasing distance from the center indicates increased warning levels. This would be ideal in the case where all data series are desired to be in a “low” state. Conversely, the data series could be normalized so that the “safe” range is at the outer edge (state “5” in FIG. 3) and increasing distance from the outer edge indicates increased warning levels. This would be ideal in the case where all data series are desired to be in a “high” state.

In other embodiments, the data graph 10 may not be normalized, but may simply display the lower end of values toward the center (such as in state “1” in FIG. 3), and the higher end of values at the edge (such as in state “5” in FIG. 3). Conversely, the values could be inverted so that the higher end of values are displayed toward the center (such as in state “1” in FIG. 3), and the lower end of values are displayed at the edge (such as in state “5” in FIG. 3). In a display such as this, the advantageous “unbroken” circle indicating all “safe” values would not exist.

In one embodiment, the bounded area 12 has a white background color, and each segment 14 has five concentric portions 16, with the most centrally-located portion (state “1” in FIG. 3) being a “low out-of-spec” state and displayed in red, the next portion out (state “2” in FIG. 3) being a “low, but in-spec” state and displayed in yellow, the next portion out (state “3” in FIG. 3) being an “in-spec” state and displayed in green, the next portion out (state “4” in FIG. 3) being a “high, but in-spec state” and displayed in yellow, and the outermost portion (state “5” in FIG. 3) being a “high out-of-spec” state and displayed in red. In this embodiment, a viewer would see an unbroken green circle on a white background if all parameters are “in-spec”, but a broken circle if one or more parameter varies from the “in-spec” state. Yellow broken portions of the circle would indicate that the process conditions are not ideal, but are acceptable, while red broken portions of the circle would indicate that the process conditions are unacceptable or even dangerous. FIG. 7 shows an example of such a data display shape in which five of the states are in a “safe” range, indicated by the middle concentric portion being highlighted in green, and two states in a “high critical” range, indicated by two outer concentric portions being highlighted in red.

In yet another embodiment, the bounded area 12 has a white or black background color, and each segment 14 has five concentric portions, with the most centrally-located portion (state “1” in FIG. 3) being a “safe” state and displayed in green, the next portion out (state “2” in FIG. 3) being a “slightly high, but in-spec” state and displayed in yellow-green, the next portion out (state “3” in FIG. 3) being a “high and out-of-spec” state and displayed in yellow, the next portion out (state “4” in FIG. 3) being a “high warning” and displayed in orange, and the outermost portion (state “5” in FIG. 3) being a “high danger” state and displayed in red. In this embodiment, a viewer would see an unbroken green circle if all parameters are “safe”, but a broken circle if one or more parameter varies from the “safe” state. Yellow broken portions of the circle would indicate that the process conditions are not in spec, while red broken portions of the circle would indicate that the process conditions are dangerous.

In some embodiments, the status of certain parameters can be emphasized by causing selected radial segments 14 and/or concentric portions 16 to blink or cycle through colors. For instance, any concentric portions colored in red could blink to more easily capture the viewer's attention, especially if the user is colorblind. The data graph may also have sound-producing capabilities, such that alarms could sound to indicate warning, critical, or dangerous levels of any of the parameters.

In some embodiments, the data graph 10 is able to display data in real-time or with very little delay. This gives viewers an up-to-date picture of the status of all the parameters data series being displayed. For instance, when the data graph 10 is being used to display process parameters for a piece of equipment, the user can see the status of each of the process parameters all at once as the equipment is used.

Each radial segment of the data graph may also be used to display more than one data series. For instance, the concentric portions could be arranged so that different states for any variable can be nested inside one another. FIG. 10 shows a data graph 10A where three variables are represented in a nested configuration. The inner five concentric portions 16A may represent one data series and are surrounded by a gray separator 17A. The inner data series may represent a state such as fill level, where an outer green portion indicates a filled state, and an inner red portion indicates an empty state. The next three concentric portions 16B may represent a second data series and are also outlined by a gray separator 17B. The middle data series may represent a normalized state, where a green center portion indicates the “safe” value, and an inner or outer yellow portion indicates a “warning” value. A third data series is represented by the concentric portion 16C at the outer edge of the data graph. The outer series could simply be a user-defined variable that can be represented as the background color, or highlighted in different colors, such as red or green, in order to indicate the status of that variable such as “on” or “off”.

The data graph 10 may also be used to display progress or idle time when not used to display data. For example, it could be used as a “loading” indicator by highlighting the concentric portions in sequence either toward the center, outward, or around the diameter of the display shape. Alternatively, radial segments could be highlighted in sequence around the diameter of the display shape to show progress. Similarly, in addition to or instead of the radial segments or concentric portions being highlighted in sequence, all or some of the portions or segments could remain highlighted, but change color.

The above described embodiments of data graph 10, 10A and other embodiments allow viewers to see, at a glance, the current state or states of a system via a symmetrical grid. The design of the data graph takes advantage of a viewer's natural pattern recognition abilities to quickly identify non-conforming data points. In addition to leveraging pattern recognition, the design of the data graph also uses both position and color variations to indicate state, making it unambiguous even to colorblind users. The data graph combines the benefits of a column/bar graph to represent state, and a pie/spider chart to contain the data set (i.e., large data sets can be seen in a small space). The invention also provides ways to interact with the data graph. The unique combination of these technologies allows for a compact and touch-friendly user interface.

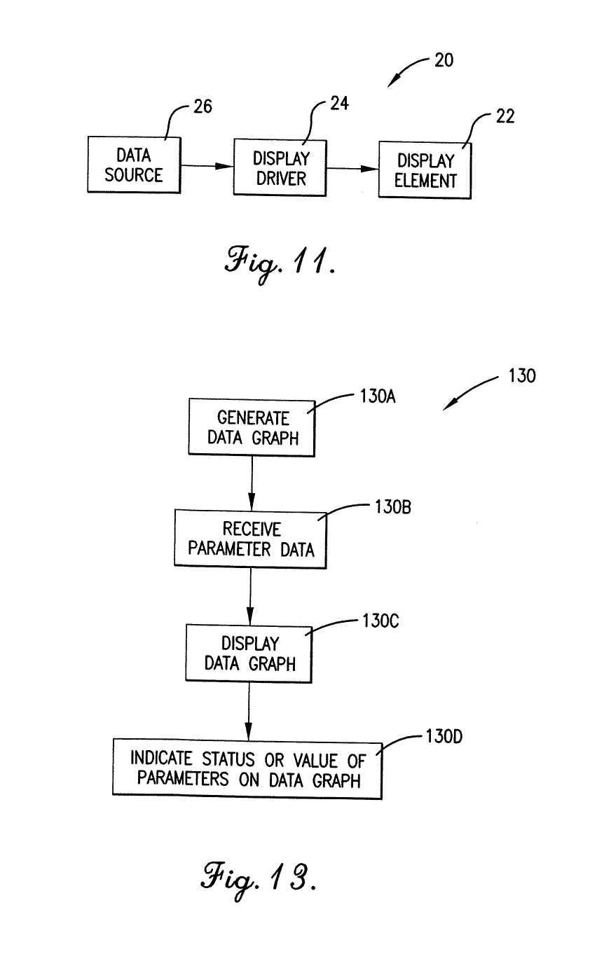

The above-described data graphs 10, 10A may be implemented with any device, system, or method. In one embodiment, one of the data graphs may be implemented with a user interface 20 that monitors a manufacturing system or other system that has a number of parameters each having several states or values. An embodiment of the user interface 20 is shown in FIG. 11 and broadly comprises an electronic display element 22, a display driver 24, and a data source 26. The display element 22 may be any display device such as a liquid crystal display (LCD), a touchscreen LCD, a light emitting diode (LED) display, or a retina display. In one embodiment, the display element 22 is incorporated in a mobile phone or other handheld mobile communication device.

The display driver 24 may be any hardware and/or software device capable of controlling the electronic display element 22 so as to display the data graph 10 thereon. The data source 26 may be any source of data to be displayed such as a computer, computer system, sensors monitoring system, etc. The display driver 24 receives data representative of a current state or value of each of the parameters of the monitored system from the data source 26 and indicates the current state or value of the parameters by marking the concentric portions that represent the current states or values as described above.

When the data graph is implemented with a user interface 20 such as the one described above, optional input devices can be used to interact with the data graph. For example, the radial segment of the data graph may be linked to data tables or other data sources so that specific data may be displayed when a user clicks-on, hovers-over, scrolls-through or otherwise selects a particular concentric portion. This allows a viewer to quickly and easily learn more about a parameter that is currently outside its desired value or state.

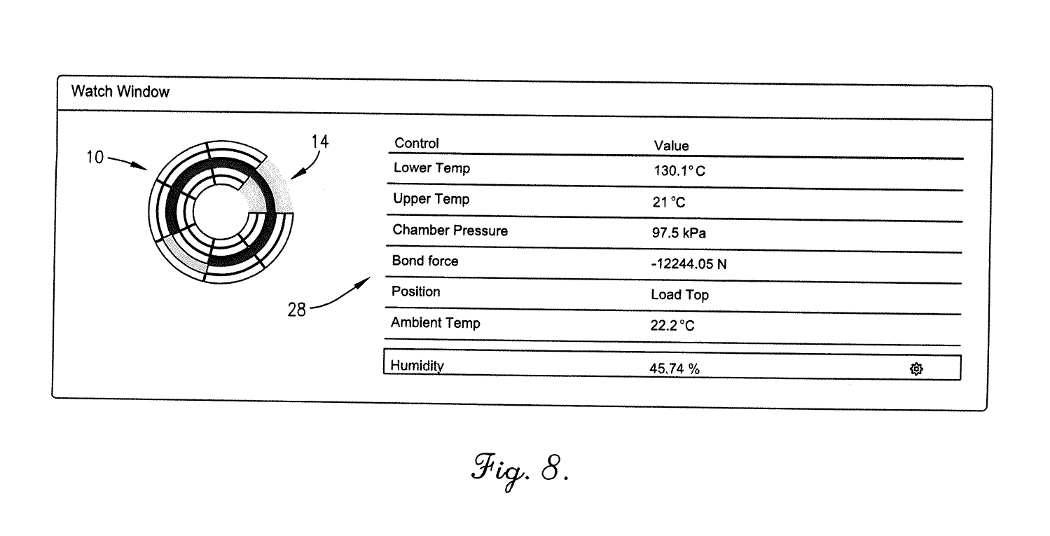

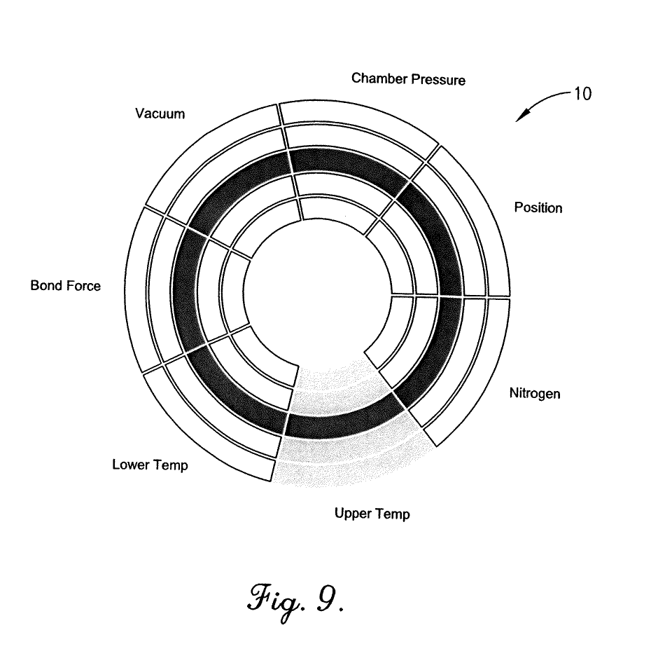

For instance, if the data graph is displayed on a computer screen or mobile phone screen, a user is able to “mouse-over” or “click” different sections of the data graph, or, if the data graph is displayed on a touch screen, a user could simply touch the segment or portion for which the user would like to see more information. By interacting with the data graph, the user can access more detailed information on the data series displayed in that segment or portion. For example, as shown in FIG. 8, a data graph 10 may be shown alongside a table of data 28 that includes data from a highlighted segment 14 of the data graph. By selecting the highlighted segment of the display graph, the user is able to display the actual values for the corresponding parameter (in this case “humidity”), rather than just knowing that the value was in-spec. The information displayed by selecting the segment could be shown over the display shape, in the central hole 18 in the bounded area, or in another display area.

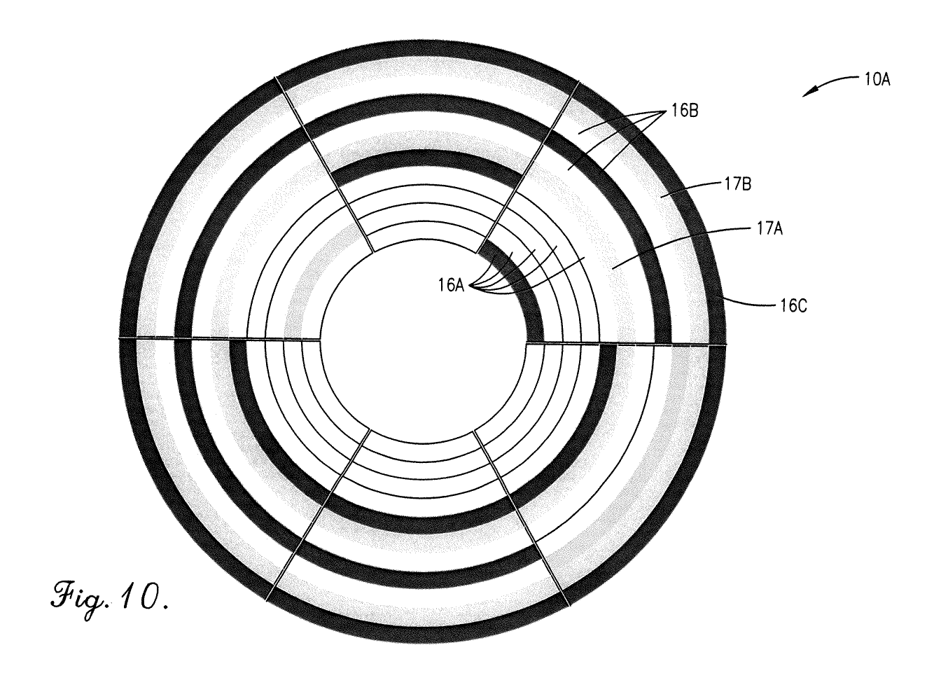

Optionally, text or graphics can be displayed on or near the data graph 10. FIG. 9 shows a data graph with optional labels shown outside of the data graph. The text or graphics could be used to show the values being displayed on the data graph, or to label the different segments or portions of the data graph. While displaying text or graphics on or near the data graph may cause the display area to be larger, it can help the user more immediately identify exactly which data series are “out of spec” or at warning levels. Additionally, clicking on the text corresponding to a radial segment can highlight the radial segment.

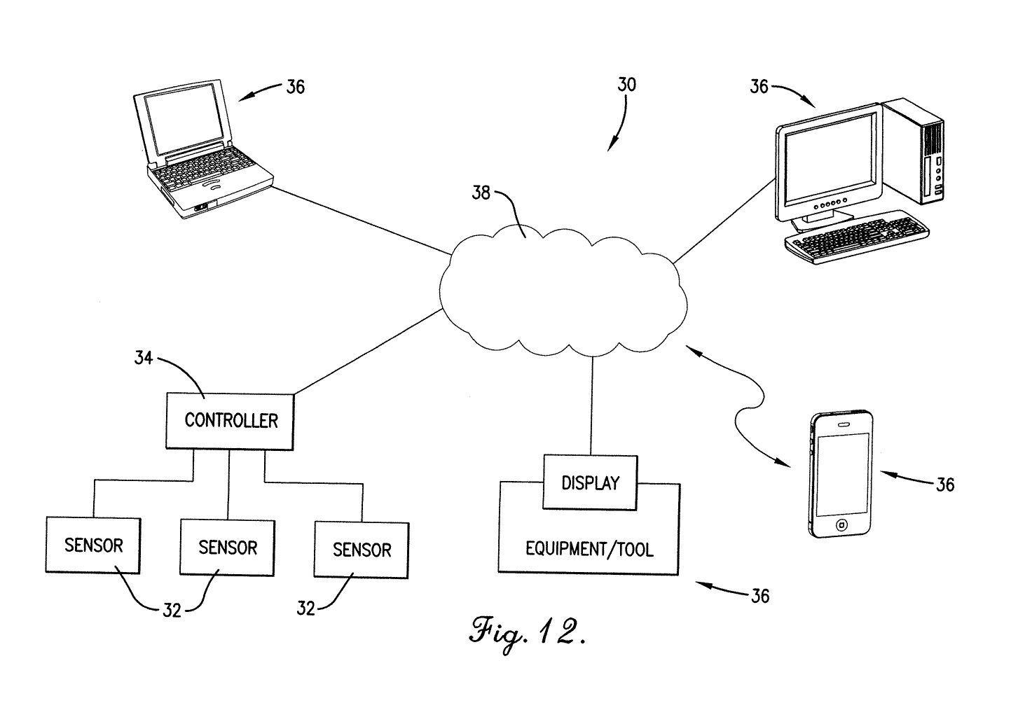

In another embodiment of the invention depicted in FIG. 12, a data graph 10 may be implemented in a monitoring system 30 that monitors a number of parameters of a manufacturing system or other system. The illustrated monitoring system 30 broadly comprises a plurality of sensors 32, a controller 34, and a number of electronic devices 36 that each receive data from the controller 34 and include or implement a user interface for presenting the data graph to users of the monitoring system.

The sensors 32 are configured for monitoring parameters of the system and may be temperature sensors, level sensors, flow sensors, humidity sensors, pressure sensors, or any other type of sensor.

The controller 34 receives signals from the sensors, wherein the signals each represent a current state or value of one of the sensors. The controller may be a computer, computer system, or any other hardware and/or software device capable of receiving signals from the sensors and providing corresponding data to the electronic devices.

The electronic devices 36 may be laptop computers, desktop computers, computers or hardware integrated into a piece of monitored equipment or tool, and/or mobile communication devices such as smart phones. Each electronic device includes or implements a user interface. Some of the electronic devices may also include a wireless communication component operable to wirelessly receive data representative of the signals from the controller. Each user interface may be substantially similar to the user interface described above and may comprise an electronic display element and a display driver for controlling the electronic display element so as to display the above-described data graph thereon. In other embodiments, the user interface is integrated into a piece of equipment, tool, or other device being monitored by the monitoring system.

The electronic devices 36 may communicate with the controller 34 via a communications network 38 or may be wired directly to the controller 34. The communications network 38 may be the Internet or any other wired or wireless communications network such as a local area network, a wide area network, a Bluetooth Network, or an intranet. The communications network 38 may include or be in communication with a wireless network capable of supporting wireless communications such as the wireless networks operated by AT&T, Verizon, or Sprint. The wireless network may include conventional switching and routing equipment. The communications network and wireless network may also be combined or implemented with several different networks.

The components of the monitoring system 30 illustrated and described herein are merely examples of equipment that may be used to implement embodiments of the present invention and may be replaced with other equipment without departing from the scope of the present invention. Some of the illustrated components of the system 10 may also be combined or removed entirely.

In yet another embodiment, the data graph may be implemented with a non-transitory computer-readable medium having one or more computer programs stored thereon for controlling operation of an electronic display element. The computer program instructs the display element to display the above-described data graph.

Each computer program preferably comprises an ordered listing of executable instructions for implementing logical functions in the controller and/or the display driver. Each computer program can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can store the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

Each computer program may utilize menu functions to permit an operator to access all of its functions. Certain features of the programs are available in a pop-up menu available at the right click of the mouse over the data space or other input command. The right click menu may, for example, include features to change a data graph. The computer program may also display a dashboard as an alternate access to controls and system settings. The menu functions may also be implemented with touchscreen display technologies.

In yet another embodiment, the data graph 10 is implemented in a method of indicating a current status or value of a number of parameters of a manufacturing system or other system. The flow chart of FIG. 13 shows the functionality and operation of a preferred implementation of one exemplary method 130 in more detail. In this regard, some of the blocks of the flow chart may represent steps in the method and/or a module segment or portion of code of the computer programs of the present invention. In some alternative implementations, the functions noted in the various blocks may occur out of the order depicted in FIG. 13. For example, two blocks shown in succession in FIG. 13 may in fact be executed substantially concurrently, or the blocks may sometimes be executed in the reverse order depending upon the functionality involved.

The method 130 comprises generating a data graph as depicted in step 130A. The data graph may be any of the embodiments of the data graph described above. The method further comprises receiving data representative of a current status or value of each of the parameters of the system as depicted in step 130B. The method further comprises the step of displaying the above-described data graph on an electronic display element as depicted in step 130C. The method further comprises indicating the current status or values of the parameters by marking the concentric portions of the data graph that represent the current states or values as depicted in step 13D. The data graph displayed in this method and other embodiments of the method may be the same as the data graphs described above in connection with the other embodiments with the invention.

In all of the above-described embodiments of the invention, labels, text, graphics, or other values associated with a segment may be set by clicking on the segment and entering the desired information.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A user interface for monitoring a number of parameters of a system, the parameters each having a number of states or values, the user interface comprising:
an electronic display element; and
a display driver for controlling the electronic display element so as to display a data graph on the electronic display element, the data graph including—
a bounded area divided into a plurality of segments, each segment representing one of the parameters;
a number of concentric portions formed in each segment, each concentric portion representing one of the states or values of the parameter represented by its corresponding segment;
wherein the display driver receives data representative of current states or values of the parameters and indicates the current states or values of the parameters by marking the concentric portions that represent the current states or values.

2. The user interface as set forth in claim 1, wherein the system is a laboratory or manufacturing system, and the parameters are selected from the group consisting of temperature, pressure, position, liquid level, flow rate, humidity level, force, voltage, current, power, wavelength, frequency, intensity, and concentration.

3. The user interface as set forth in claim 1, wherein the system is an accounting or financial system, and the parameters are selected from the group consisting of expenses, revenue, budget, profit, and loss.

4. The user interface as set forth in claim 1, wherein the display driver marks the concentric portions that represent the current states or values by coloring the concentric portions, shading the concentric portions, or cross-hatching the concentric portions.

5. The user interface as set forth in claim 4, wherein the display driver colors the concentric portions by changing colors of the concentric portions from a background color to a more visible color.

6. The user interface as set forth in claim 1, wherein the bounded area is circular in shape and wherein the segments are equally-sized and pie-shaped radial segments.

7. The user interface as set forth in claim 1, wherein the display driver receives the data representative of the current states or values of the parameters in substantially real-time.

8. The user interface as set forth in claim 1, wherein the electronic display element and the display driver are incorporated into a mobile communications device.

9. The user interface as set forth in claim 1, wherein each of the segments includes at least a first concentric portion and a second concentric portion, and wherein the first concentric portions of all the segments are concentrically aligned to form a relatively unbroken ring and the second concentric portions of all the segments are concentrically aligned to form another relatively unbroken ring.

10. A user interface for monitoring a number of parameters of a system, the parameters each having a number of states or values, the user interface comprising:
an electronic display element;
a display driver for controlling the electronic display element so as to display a data graph thereon, the data graph including—
a circular bounded area divided into a plurality of equally-sized radial segments, each radial segment representing one of the parameters;
a number of concentric portions formed in each radial segment, each concentric portion representing one of the states or values of the parameter represented by its corresponding radial segment; and
a communication component coupled with the display driver and operable to receive data representative of current states or values of the parameters in substantial real-time, wherein the display driver indicates the current states or values of the parameters by coloring the concentric portions that represent the current states or values.

11. The user interface as set forth in claim 10, wherein the system is a laboratory or manufacturing system, and the parameters are selected from the group consisting of temperature, pressure, position, liquid level, flow rate, humidity level, force, voltage, current, power, wavelength, frequency, intensity, and concentration.

12. The user interface as set forth in claim 10, wherein the system is an accounting or financial system, and the parameters are selected from the group consisting of expenses, revenue, budget, profit, and loss.

13. The user interface as set forth in claim 10, wherein the display driver marks the concentric portions that represent the current states or values by coloring the concentric portions, shading the concentric portions, or cross-hatching the concentric portions.

14. The user interface as set forth in claim 13, wherein the display driver colors the concentric portions by changing colors of the concentric portions from a background color to a more visible color to mark the concentric portions.

15. The user interface as set forth in claim 10, wherein the electronic display element, the display driver, and the wireless communication component are incorporated into a mobile communications device.

16. The user interface as set forth in claim 10, wherein each of the radial segments includes at least a first concentric portion and a second concentric portion and wherein the first concentric portions of all the radial segments are concentrically aligned and the second concentric portions of all the radial segments are concentrically aligned.

17. The user interface as set forth in claim 10, wherein the communication component is a wireless communication component.

18. A monitoring system for monitoring parameters of a system, the parameters each having a number of states or values, the monitoring system comprising:
a plurality of sensors each configured for monitoring one of the parameters of the system;
a controller for receiving a signal from each of the sensors, the signals each representing a current state or value of one of the parameters;
a user interface coupled with the controller, the user interface comprising—
a communication component operable to receive data representative of the signals from the controller;
an electronic display element; and
a display driver coupled with the communication component for controlling the electronic display element so as to display a data graph thereon, the data graph including—
a bounded area divided into a plurality of evenly-sized radial segments, each radial segment representing one of the parameters; and
a number of concentric portions formed in each radial segment, each concentric portion representing one of the states or values of the parameter represented by its corresponding radial segment, wherein the display driver indicates the current states or values of the parameters by marking the concentric portions that represent the current states or values.

19. The monitoring system as set forth in claim 18, wherein the system is a laboratory or manufacturing system, and the parameters are selected from the group consisting of temperature, pressure, position, liquid level, flow rate, humidity level, force, voltage, current, power, wavelength, frequency, intensity, and concentration.

20. The monitoring system as set forth in claim 18, wherein the system is a financial system, and the parameters are selected from the group consisting of expenses, revenue, budget, profit, and loss.

21. The monitoring system as set forth in claim 18, wherein the display driver marks the concentric portions that represent the current states or values by coloring the concentric portions, shading the concentric portions, or cross-hatching the concentric portions.

22. The monitoring system as set forth in claim 21, wherein the display driver changes the colors of the concentric portions from a background color to a more visible color to mark the concentric portions.

23. The monitoring system as set forth in claim 18, wherein the bounded area is circular in shape and wherein the radial segments are equally-sized and pie-shaped.

24. The monitoring system as set forth in claim 18, wherein the display driver receives the data representative of the current states or values of the parameters in substantially real-time.

25. The user interface as set forth in claim 18, wherein the communication component is a wireless communication component.

26. The monitoring system as set forth in claim 25, wherein the user interface is incorporated into a mobile communications device.

27. The monitoring system as set forth in claim 18, wherein each of the radial segments includes at least a first concentric portion and a second concentric portion and wherein the first concentric portions of all the radial segments are concentrically aligned and the second concentric portions of all the radial segments are concentrically aligned.

28. A non-transitory computer-readable medium having a computer program stored thereon, wherein the computer program instructs a display driver to perform the following steps:
display a data graph on an electronic display element, the data graph including—
a bounded area divided into a number of segments, wherein each segment represents a parameter of a system, each parameter having a number of states or values; and
a number of concentric portions formed in each segment, wherein each concentric portion represents a state of value of one of the parameters; and
indicate a current state or value of each of the parameters on the electronic display element by marking the concentric portions that represent the current states or values.

29. The non-transitory computer-readable medium as set forth in claim 26, wherein the system is a laboratory or manufacturing system, and the parameters are selected from the group consisting of temperature, pressure, position, liquid level, flow rate, humidity level, force, voltage, current, power, wavelength, frequency, intensity, and concentration.

30. The non-transitory computer-readable medium as set forth in claim 28, wherein the system is an accounting or financial system, and the parameters are selected from the group consisting of expenses, revenue, budget, profit, and loss.

31. The non-transitory computer-readable medium as set forth in claim 28, wherein the display driver marks the concentric portions that represent the current states or values by coloring the concentric portions, shading the concentric portions, or cross-hatching the concentric portions.

32. The non-transitory computer-readable medium as set forth in claim 31, wherein the display driver colors the concentric portions by changing colors of the concentric portions from a background color to a more visible color.

33. The non-transitory computer-readable medium as set forth in claim 28, wherein the bounded area is circular in shape and wherein the segments are equally-sized and pie-shaped radial segments.

34. The non-transitory computer-readable medium as set forth in claim 28, wherein the display driver receives data representative of the current states or values of the parameters in substantially real-time.

35. The non-transitory computer-readable medium as set forth in claim 28, wherein the electronic display element is incorporated into a mobile communications device.

36. The non-transitory computer-readable medium as set forth in claim 28, wherein each of the segments includes at least a first concentric portion and a second concentric portion, and wherein the first concentric portions of all the segments are concentrically aligned and the second concentric portions of all the segments are concentrically aligned.

37. A method of indicating a current status or value of a number of parameters of a system, the parameters each having a number of possible states or values, the method comprising:
receiving data representative of the current status or value of each of the parameters;
displaying a data graph on an electronic display element, the data graph including—
a bounded area divided into a number of segments, wherein each segment represents one of the parameters; and
a number of concentric portions formed in each segment, wherein each concentric portion represents one of the possible states or values of its corresponding parameter; and
indicating the current status or value of the parameters by marking the concentric portions that represent the current states or values.

38. The method as set forth in claim 35, wherein the system is a laboratory or manufacturing system, and the parameters are selected from the group consisting of temperature, pressure, position, liquid level, flow rate, humidity level, force, voltage, current, power, wavelength, frequency, intensity, and concentration.

39. The method as set forth in claim 37, wherein the system is an accounting or financial system, and the parameters are selected from the group consisting of expenses, revenue, budget, profit, and loss.

40. The method as set forth in claim 37, wherein the concentric portions that represent the current states or values are marked by coloring the concentric portions, shading the concentric portions, or cross-hatching the concentric portions.

41. The method as set forth in claim 40, wherein concentric portions are colored by changing colors of the concentric portions from a background color to a more visible color.

42. The method as set forth in claim 37, wherein the bounded area is circular in shape and wherein the segments are equally-sized and pie-shaped radial segments.

43. The method as set forth in claim 37, further comprising receiving data representative of the current states or values of the parameters in substantially real-time.

44. The method as set forth in claim 37, wherein each of the segments includes at least a first concentric portion and a second concentric portion, and wherein the first concentric portions of all the segments are concentrically aligned and the second concentric portions of all the segments are concentrically aligned.

45. A method of indicating a current status or value of parameters of a manufacturing system, the parameters each having a number of possible states or values, the method comprising:
receiving from a communication device data representative of a current status or value of each of the parameters, wherein the parameters are selected from the group consisting of temperature, pressure, position, liquid level, flow rate, humidity level, force, voltage, current, power, wavelength, frequency, intensity, and concentration;
displaying a data graph on an electronic display element coupled with the communication device, the data graph including—
a bounded area divided into a number of radial segments, wherein each radial segment represents one of the parameters;
a number of concentric portions formed in each radial segment, wherein each concentric portion represents one of the possible states or values of its corresponding parameter; and
indicating the current status or value of the parameters by marking the concentric portions that represent the current states or values.
